(19) United States
(12) Patent Application Publication
(10) Pub. No.: US 2005/0259525 A1
(43) Pub. Date: Nov. 24, 2005

(54) Method and apparatus for identifying an optical disc in an optical storage system

(75) Inventors: Han-Wen Hsu, Hsin-Chu City (TW); Chih-Peng Ma, Hsin-Chu City (TW)

Correspondence Address: PILLSBURY WINTHROP SHAW PITTMAN, LLP, P.O. BOX 10500, MCLEAN, VA, 22102, US

(73) Assignee: MEDIATEK INC., Hsin-Chu City (TW)

(21) Appl. No.: 11/129,485

(22) Filed: May 16, 2005

(30) Foreign Application Priority Data
May 24, 2004 (TW) 93114600

(51) Int. Cl. G11B 7/00

(52) U.S. Cl. 369/44.13; 369/53.1; 369/53.28; 369/44.27

(57) ABSTRACT

An apparatus is adapted for identifying an optical disc loaded in an optical storage system that is capable of generating a wobble signal corresponding to a detected wobble track of the optical disc. The apparatus includes a feature parameter extractor and a comparing unit. The feature parameter extractor is adapted for receiving the wobble signal from the optical storage system, and is operable so as to extract a feature parameter of the wobble signal. The comparing unit is coupled to the feature parameter extractor, and is operable so as to identify the optical disc by comparing the feature parameter extracted by the feature parameter extractor with a predetermined threshold value.

### CROSS-REFERENCE TO RELATED APPLICATION

This application claims priority of Taiwanese application no. 093114600, filed on May 24, 2004.

### BACKGROUND OF THE INVENTION

1. Field of the Invention

The invention relates to a method and apparatus for identifying an optical disc in an optical storage system, more particularly to a method and apparatus for identifying an optical disc in an optical storage system by extracting a feature parameter of a wobble signal generated by the optical storage system and corresponding to a detected wobble track of the optical disc.

2. Description of the Related Art

According to the industry specification of Digital Versatile Discs (DVD), it is necessary to form a wobble track on a Read-Only/Rewritable optical disc so that an optical pickup device of an optical storage system loaded with the optical disc is able to perform accurate addressing and rotation control through detection of the wobble track when reading the optical disc. Since the wobble track wobbles in a sinusoidal manner so as to store information for addressing and rotation control, the optical pickup device is able to generate a wobble signal that contains the aforesaid information through detection of the wobble track before reading data from or recording data onto the optical disc. Subsequently, by analyzing changes in the frequency and waveform of the wobble signal, addressing and motor rotation control can be conducted for precise data reading and recording.

Different wobble signals are generated in accordance with the wobbling manner of the wobble tracks. As shown in FIG. 1, a wobble track of a DVD+R/+RW optical disc results in a wobble signal with signal cycle 32T (i.e., a high-frequency signal). Information for addressing and rotation control is stored through phase variation of a sinusoidal wave. On the other hand, as shown in FIG. 2, a wobble track of a DVD-R/-RW optical disc results in a wobble signal with signal cycle 186T (i.e., a low-frequency signal as compared to that shown in FIG. 1). Since information for addressing and rotation control is stored through pre-pits formed in the wobble track, the wobble signal is a sinusoidal wave having pulse surges that correspond to the pre-pits.

In the prior art, identification of an optical disc loaded in an optical storage system is made possible by detecting the frequency of the wobble signal or by detecting the presence of pulse surges in the wobble signal.

### SUMMARY OF THE INVENTION

The object of the present invention is to provide a method and apparatus for identifying an optical disc in an optical storage system by extracting a feature parameter of a wobble signal generated by the optical storage system and corresponding to a detected wobble track of the optical disc.

According to one aspect of the present invention, there is provided a method for identifying an optical disc that is placed on an optical storage system. The optical storage system is capable of generating a wobble signal corresponding to a wobble track of the optical disc upon detection of the wobble track. The method comprises the steps of:
a) extracting a feature parameter of the wobble signal; and
b) identifying the optical disc by comparing the feature parameter extracted in step a) with a predetermined threshold value.

According to another aspect of the present invention, there is provided an apparatus for identifying an optical disc loaded in an optical storage system. The optical storage system is capable of generating a wobble signal corresponding to a wobble track of the optical disc upon detection of the wobble track. The apparatus comprises a feature parameter extractor and a comparing unit.

The feature parameter extractor is adapted for receiving the wobble signal from the optical storage system, and is operable so as to extract a feature parameter of the wobble signal.

The comparing unit is coupled to the feature parameter extractor, and is operable so as to identify the optical disc by comparing the feature parameter extracted by the feature parameter extractor with a predetermined threshold value.

### BRIEF DESCRIPTION OF THE DRAWINGS

Other features and advantages of the present invention will become apparent in the following detailed description of the preferred embodiment with reference to the accompanying drawings, of which:

FIG. 1 illustrates an exemplary wobble signal associated with a DVD+R/+RW optical disc;

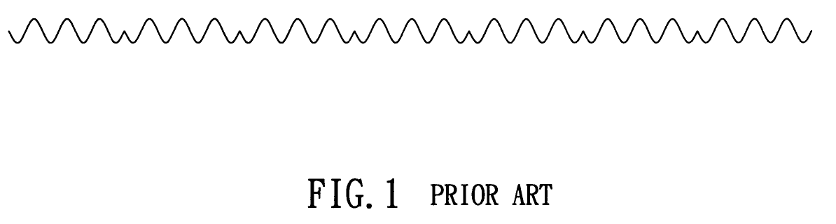

FIG. 2 illustrates an exemplary wobble signal associated with a DVD-R/-RW optical disc;

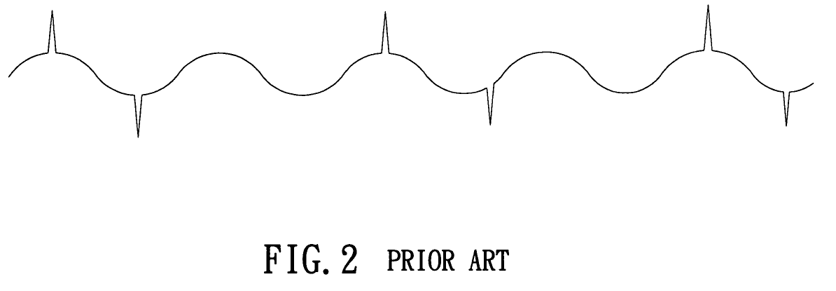

FIG. 3 is a schematic circuit block diagram of the preferred embodiment of an apparatus for identifying an optical disc according to the present invention;

FIG. 4 illustrates an exemplary wobble signal associated with a DVD+R/+RW optical disc before and after being subjected to filtering according to the preferred embodiment; and

FIG. 5 illustrates an exemplary wobble signal associated with a DVD-R/-RW optical disc before and after being subjected to filtering according to the preferred embodiment.

### DETAILED DESCRIPTION OF THE PREFERRED EMBODIMENT

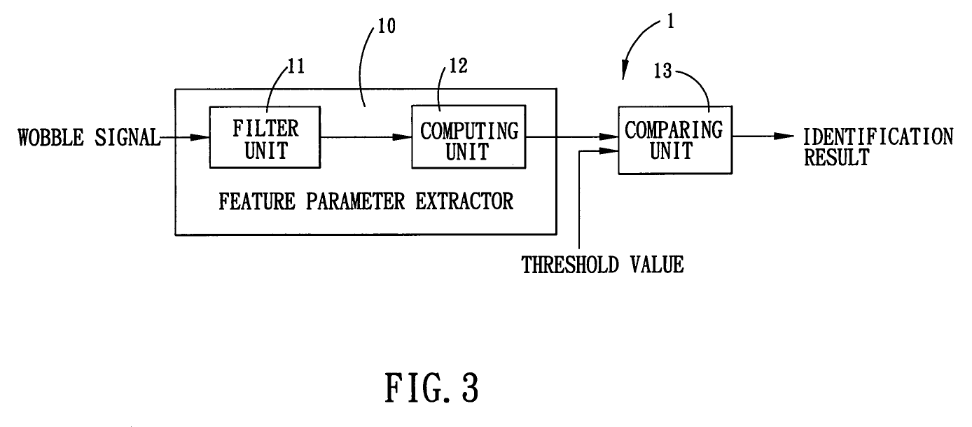

FIG. 3 is a schematic circuit block diagram of the preferred embodiment of an apparatus 1 for identifying an optical disc according to the present invention. The apparatus 1 is adapted for use in an optical storage system so as to identify whether an optical disc loaded in the optical storage system is a DVD+R/+RW or a DVD-R/-RW optical disc, thereby enabling the optical storage system to proceed with appropriate addressing and rotation control during reading and recording operations.

The apparatus 1 comprises a feature parameter extractor 10 and a comparing unit 13.

The feature parameter extractor 10 is adapted for receiving the wobble signal from the optical storage system, and is operable so as to extract a feature parameter of the wobble signal. In this embodiment, the feature parameter extractor 10 includes a filter unit 11 and a computing unit 12.

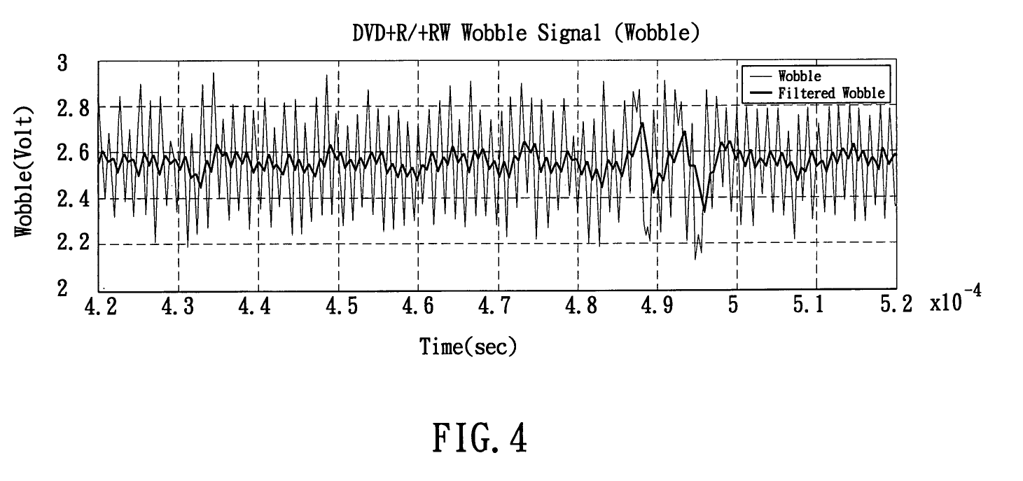

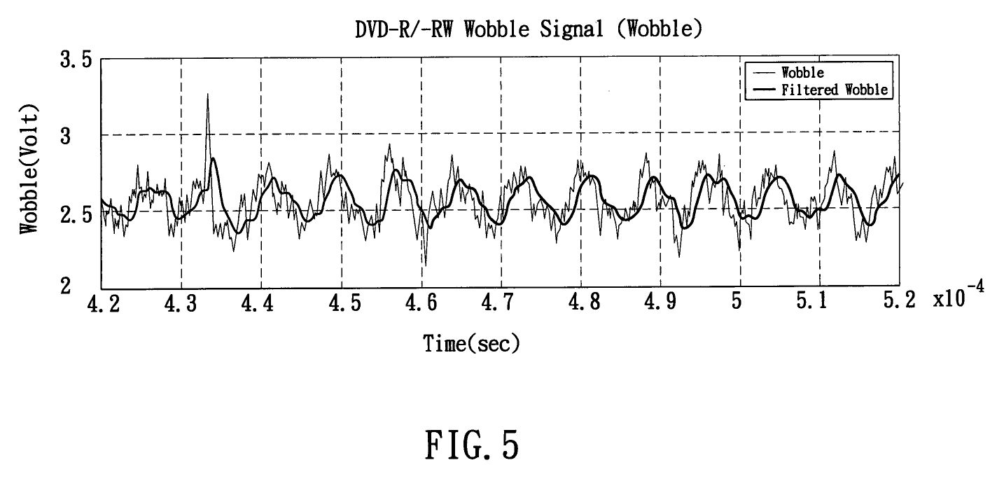

The filter unit 11 filters the wobble signal so as to obtain a filtered signal having an amplitude that is adjusted according to frequency of the wobble signal. In this embodiment, the filter unit 11 is a low-pass filter such that a low-frequency wobble signal associated with a DVD-R/-RW optical disc experiences small attenuation, as best shown in FIG. 5, whereas a high-frequency wobble signal associated with a DVD+R/+RW optical disc experiences large attenuation, as best shown in FIG. 4. As evident from FIGS. 4 and 5, the amplitudes of the filtered wobble signal for a DVD+R/+RW optical disc are much smaller than those of the filtered wobble signal for a DVD-R/-RW optical disc.

The computing unit 12 is coupled to the filter unit 11 so as to receive the filtered wobble signal therefrom, and is used to extract the feature parameter of the wobble signal through mathematical computations or algorithms. The computing unit 12 is configured to extract the feature parameter using any of the following schemes, where ω_{M}(t) is the wobble signal of a DVD-R/-RW optical disc, ω_{P}(t) is the wobble signal of a DVD+R/+RW optical disc, DCM is a direct current component of ω_{M}(t), and DC_{P} is a direct current component of ω_{P}(t)

(First Scheme) Integrating an absolute value of the wobble signal within a sufficient time period (i.e., t₂−t₁) after removing the direct current component from the wobble signal.

$${\int }_{t1}^{t2} \vert {ω}_{M} ( t ) - {DC}_{M} \vert ⅆ t = 2135$$

$${\int }_{t1}^{t2} \vert {ω}_{P} ( t ) - {DC}_{P} \vert ⅆ t = 855.7$$

In the first scheme, the ratio of the extracted feature parameter of the wobble signal of a DVD-R/-RW optical disc to that of the wobble signal of a DVD+R/+RW optical disc is 2135/855.7=2.49

(Second Scheme) Integrating an nth power of an absolute value of the wobble signal within a sufficient time period (i.e., t₂−t₁) after removing the direct current component from the wobble signal, where n is an integer larger than 1. In the following example, n=2.

$${\int }_{t1}^{t2} {\vert {ω}_{M} ( t ) - {DC}_{M} \vert}^{2} ⅆ t = 260.8265$$

$${\int }_{t1}^{t2} {\vert {ω}_{P} ( t ) - {DC}_{P} \vert}^{2} ⅆ t = 54.1137$$

In the second scheme, the ratio of the extracted feature parameter of the wobble signal of a DVD-R/-RW optical disc to that of the wobble signal of a DVD+R/+RW optical disc is 260.8265/54.1137=4.82

(Third Scheme) Integrating an exponential function of an absolute value of the wobble signal within a sufficient time period (i.e., t₂−t₁) after removing the direct current component from the wobble signal. In the following example, c is a sufficiently large constant, such as 20.

$${\int }_{t1}^{t2} exp ( c \vert {ω}_{M} ( t ) - {DC}_{M} \vert ) ⅆ t = 3.2975 \times {10}^{5}$$

$${\int }_{t1}^{t2} exp ( c \vert {ω}_{P} ( t ) - {DC}_{P} \vert ) ⅆ t = 6.9696 \times {10}^{4}$$

In the third scheme, the ratio of the extracted feature parameter of the wobble signal of a DVD-R/-RW optical disc to that of the wobble signal of a DVD+R/+RW optical disc is 3.2975×10⁵/6.9696×10⁴=2.49

(Fourth Scheme) Integrating a tangential function of an absolute value of the wobble signal within a sufficient time period (i.e., t₂−t₁) after removing the direct current component from the wobble signal. In the following example, c is a sufficiently large constant, such as 1.79.

$${\int }_{t1}^{t2} tan ( c \vert {ω}_{M} ( t ) - {DC}_{M} \vert ) ⅆ t = 1.6331 \times {10}^{16}$$

$${\int }_{t1}^{t2} tan ( c \vert {ω}_{P} ( t ) - {DC}_{P} \vert ) ⅆ t = 3.9661 \times {10}^{3}$$

In the fourth scheme, the ratio of the extracted feature parameter of the wobble signal of a DVD-R/-RW optical disc to that of the wobble signal of a DVD+R/+RW optical disc is 1.6331×10¹⁶/3.9661×10³−4.11×10¹²

It is apparent from the foregoing that the ratio of the extracted feature parameter of the wobble signal of a DVD-R/-RW optical disc to that of the wobble signal of a DVD+R/+RW optical disc is sufficiently large (>2.49) in all of the aforesaid schemes such that a value falling in the middle of any pair of the extracted feature parameters may be arbitrarily selected as a predetermined threshold value for use by the comparing unit 13. For instance, in the first scheme, the predetermined threshold value can be set as 855.7×1.5=1283.55.

The comparing unit 13 is coupled to the computing unit 12 of the feature parameter extractor 10, and is operable so as to identify the optical disc by comparing the feature parameter extracted by the feature parameter extractor 10 with the predetermined threshold value. In particular, the comparing unit 13 identifies the optical disc as a DVD+R/+RW optical disc when the feature parameter extracted by the feature parameter extractor 10 is smaller than the predetermined threshold value, and as a DVD-R/-RW optical disc when otherwise.

It is noted herein that the filter unit 11 may be replaced with a high-pass filter such that a high-frequency wobble signal associated with a DVD+R/+RW optical disc experiences small attenuation, whereas a low-frequency wobble signal associated with a DVD-R/-RW optical disc experiences large attenuation. In this configuration, the comparing unit 13 identifies the optical disc as a DVD-R/-RW optical disc when the feature parameter extracted by the feature parameter extractor 10 is smaller than the predetermined threshold value, and as a DVD+R/+RW optical disc when otherwise.

Moreover, when the computational scheme employed by the computing unit 12 results in a sufficiently large feature parameter ratio, such as the above fourth scheme, the filter unit 11 may be dispensed with.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for identifying an optical disc loaded in an optical storage system, the optical storage system being capable of generating a wobble signal corresponding to a wobble track of the optical disc upon detection of the wobble track, said method comprising the steps of:
a) extracting a feature parameter of the wobble signal; and
b) identifying the optical disc by comparing the feature parameter extracted in step a) with a predetermined threshold value.

2. The method as claimed in claim 1, wherein step a) includes:
a0) subjecting the wobble signal to filtering so as to obtain a filtered signal having an amplitude that is adjusted according to frequency of the wobble signal.

3. The method as claimed in claim 2, wherein, in step a0), the wobble signal is subjected to low-pass filtering such that a low-frequency wobble signal associated with a DVD-R/-RW optical disc experiences small attenuation, whereas a high-frequency wobble signal associated with a DVD+R/+RW optical disc experiences large attenuation.

4. The method as claimed in claim 3, wherein, in step b), the optical disc is identified as a DVD+R/+RW optical disc when the feature parameter obtained in step a) is smaller than the predetermined threshold value, and is identified as a DVD-R/-RW optical disc when otherwise.

5. The method as claimed in claim 1, wherein, in step a), the feature parameter is obtained by integrating an absolute value of the wobble signal after removing a direct current component from the wobble signal.

6. The method as claimed in claim 1, wherein, in step a), the feature parameter is obtained by integrating an nth power of an absolute value of the wobble signal after removing a direct current component from the wobble signal, where n is an integer larger than 1.

7. The method as claimed in claim 1, wherein, in step a), the feature parameter is obtained by integrating an exponential function of an absolute value of the wobble signal after removing a direct current component from the wobble signal.

8. The method as claimed in claim 1, wherein, in step a), the feature parameter is obtained by integrating a tangential function of an absolute value of the wobble signal after removing a direct current component from the wobble signal.

9. The method as claimed in claim 2, wherein, in step a0), the wobble signal is subjected to high-pass filtering such that a high-frequency wobble signal associated with a DVD+R/+RW optical disc experiences small attenuation, whereas a low-frequency wobble signal associated with a DVD-R/-RW optical disc experiences large attenuation.

10. The method as claimed in claim 9, wherein, in step b), the optical disc is identified as a DVD-R/-RW optical disc when the feature parameter obtained in step a) is smaller than the predetermined threshold value, and is identified as a DVD+R/+RW optical disc when otherwise.

11. An apparatus for identifying an optical disc loaded in an optical storage system, the optical storage system being capable of generating a wobble signal corresponding to a wobble track of the optical disc upon detection of the wobble track, said apparatus comprising:
a feature parameter extractor adapted for receiving the wobble signal from the optical storage system, and operable so as to extract a feature parameter of the wobble signal; and
a comparing unit coupled to said feature parameter extractor and operable so as to identify the optical disc by comparing the feature parameter extracted by said feature parameter extractor with a predetermined threshold value.

12. The apparatus as claimed in claim 11, wherein said feature parameter extractor includes a filter unit for filtering the wobble signal so as to obtain a filtered signal having an amplitude that is adjusted according to frequency of the wobble signal.

13. The apparatus as claimed in claim 12, wherein said filter unit subjects the wobble signal to low-pass filtering such that a low-frequency wobble signal associated with a DVD-R/-RW optical disc experiences small attenuation, whereas a high-frequency wobble signal associated with a DVD+R/+RW optical disc experiences large attenuation.

14. The apparatus as claimed in claim 13, wherein said comparing unit identifies the optical disc as a DVD+R/+RW optical disc when the feature parameter extracted by said feature parameter extractor is smaller than the predetermined threshold value, and as a DVD-R/-RW optical disc when otherwise.

15. The apparatus as claimed in claim 11, wherein said feature parameter extractor includes a computing unit for extracting the feature parameter by integrating an absolute value of the wobble signal after removing a direct current component from the wobble signal.

16. The apparatus as claimed in claim 11, wherein said feature parameter extractor includes a computing unit for extracting the feature parameter by integrating an nth power of an absolute value of the wobble signal after removing a direct current component from the wobble signal, where n is an integer larger than 1.

17. The apparatus as claimed in claim 11, wherein said feature parameter extractor includes a computing unit for extracting the feature parameter by integrating an exponential function of an absolute value of the wobble signal after removing a direct current component from the wobble signal.

18. The apparatus as claimed in claim 11, wherein said feature parameter extractor includes a computing unit for extracting the feature parameter by integrating a tangential function of an absolute value of the wobble signal after removing a direct current component from the wobble signal.

19. The apparatus as claimed in claim 12, wherein said filter unit subjects the wobble signal to high-pass filtering such that a high-frequency wobble signal associated with a DVD+R/+RW optical disc experiences small attenuation, whereas a low-frequency wobble signal associated with a DVD-R/-RW optical disc experiences large attenuation.

20. The apparatus as claimed in claim 19, wherein said comparing unit identifies the optical disc as a DVD-R/-RW optical disc when the feature parameter extracted by said feature parameter extractor is smaller than the predetermined threshold value, and as a DVD+R/+RW optical disc when otherwise.
